(19) United States
(12) Patent Application Publication
(10) Pub. No.: US 2009/0148588 A1
(43) Pub. Date: Jun. 11, 2009

(54) Frozen Fruit and Vegetable Bars and Methods of Making

(75) Inventors: Zhongli Pan, Davis, CA (US); Tara H. McHugh, El Cerrito, CA (US)

Correspondence Address: USDA-ARS-OFFICE OF TECHNOLOGY TRANSFER;PATENT ADVISORS OFFICE, WESTERN REGIONAL RESEARCH CENTER, 800 BUCHANAN ST, ALBANY, CA, 94710, US

(73) Assignee: The United States of America, as represented by the Secretary of Agriculture, Washington, DC (US)

(21) Appl. No.: 12/370,310

(22) Filed: Feb. 12, 2009

Related U.S. Application Data
(63) Continuation-in-part of application No. 10/917,797, filed on Aug. 13, 2004.
(60) Provisional application No. 61/028,149, filed on Feb. 12, 2008.

(51) Int. Cl. A23B 7/02; A23P 1/10

(52) U.S. Cl. 426/640; 426/515; 426/506

(57) ABSTRACT

The present invention relates to a method of manufacturing a frozen food product and to a frozen food product made thereby.

### REFERENCE TO RELATED APPLICATIONS

This application is a Continuation-in-Part of U.S. Ser. No. 10/917,797, filed Aug. 13, 2004 and claims priority thereto. This application also claims priority to U.S. Ser. No. 61/028,149, filed Feb. 12, 2008, which is incorporated herein by reference in its entirety.

### FIELD OF THE INVENTION

The invention relates to frozen fruit and vegetable bars and methods of their manufacture.

### BACKGROUND OF THE INVENTION

Good nutrition is vital to good health. Indeed, major causes of morbidity and mortality in the United States are related to poor diet and a sedentary lifestyle. The newly released Dietary Guidelines for Americans 2005 (U.S. Department of Health and Human Services and U.S. Department of Agriculture. Dietary Guidelines for Americans, 2005. 6th Edition, Washington, D.C.: U.S. Government Printing Office, January 2005), suggests that Americans strive to consume a variety of nutrient-dense foods chosen from within and among the basic food groups. Amongst the key recommendations of the Dietary Guidelines are that a sufficient amount of fruits and vegetables should be consumed while staying within energy needs. In particular, four and one half cups (nine servings) of fruits and vegetables are recommended daily to promote and maintain good health. Furthermore, it is recommended that a variety of fruits and vegetables be consumed each day and that they be chosen from all five vegetable subgroups (dark green, orange, legumes, starchy vegetables, and other vegetables).

Fruits and vegetables are rich sources of many vitamins, minerals, fiber, and phytochemicals. The consumption of fruits and vegetables are known to have many health benefits, including the prevention of cardiovascular disease, diabetes and stroke. Unfortunately, the current consumption patterns of most Americans currently do not achieve the recommended intakes of fruits and vegetables.

Thus, in order to promote a healthy population, there is a need for Americans to increase their consumption of fruits and vegetables.

Fortunately, as will be clear from the following disclosure, the present invention provides for these and other needs.

### SUMMARY OF THE INVENTION

In one exemplary embodiment, the present invention provides a method for making a frozen food product comprising fruits and/or vegetables which has the fiber and nutrients typically found in whole fruits and vegetables. In another exemplary embodiment the present invention provides a frozen food product comprising fruits and/or vegetables made by the disclosed method.

Other features, objects and advantages of the invention will be apparent from the detailed description which follows.

### BRIEF DESCRIPTION OF THE DRAWINGS

FIG. 1 shows water absorption spectrum.

FIG. 2 shows the energy emitted at various emitter/heater surface temperatures.

FIG. 3 shows schematic view of catalytic flameless gas-fired (CFG) infrared blancher/dryer. Number 1 in the drawing refers to the emitter itself; number 2 represents the food samples being treated; and number 3 is the sample holder. Please note that the sample holder can also be either a continuous belt or a rotatable drum.

FIG. 4 shows the heating rates of pear slices by IDB and 75° C. steam blanching.

FIG. 5 shows the heating rates of pear cubes by IDB and 75° C. steam blanching.

FIG. 6 shows peroxidase activity of pear samples.

FIG. 7 shows weight change of pear samples with IDB and heated air drying.

FIG. 8 shows a typical TPA texture profile of IDB and dehydrated pear.

FIG. 9 shows reflectance before and after rehydration of pear samples processed with different methods. “CD” represents the conventional steam-blanched, hot air dried method. “RH” represents “rehydration.”

### DETAILED DESCRIPTION OF THE INVENTION

### Definitions

The term “frozen food product” as used herein, refers to a frozen product comprising fruit and/or vegetables which have been pre-dehydrated using electromagnetic radiation e.g., infrared dry blanching. A frozen food product typically has a water activity that is less than about 0.98.

The term “food item” as used herein, refers to a fruit and/or vegetable which is used as the basis for producing a frozen food product according to the methods disclosed herein.

The term “fruit” as used herein, refers to the seed-bearing part of a plant that is at some time fleshy and edible. Thus, a “fruit” is any fleshy material covering a seed or seeds. Exemplary fruits include, but are not limited to blueberries, strawberries, oranges, apples, tomatoes, cantaloupe, tangerines, etc. As used herein the word fruit is understood as indicating either whole fruit or fruit pieces. Furthermore, the terms “fruit” and “fruits” refer to both the singular as well as to the plural.

The term “vegetable” as used herein, refers to all types of vegetables, including those derived from leaves, petioles, roots, bulbs, corms, tubers, etc., as well as fruits and seeds. Some exemplary vegetables include, but are not limited to e.g., tomatoes, squash, pumpkin, beans, broccoli, green beans, asparagus, peas, corn, carrots, spinach, cauliflower, lima beans, cabbage, onions, zucchini, eggplant, sweet basil, leeks etc. As used herein the word vegetable is understood as indicating either whole vegetable or vegetable pieces. Furthermore, the terms “vegetable” and “vegetables” refer to both the singular as well as to the plural.

The phrase “preparing a food item for pre-dehydration” as used herein, refers to those processes which comprise the steps needed to prepare a fruit and/or vegetable for pre-dehydration and further processing. In exemplary embodiments “preparing a food item for pre-dehydration” comprises any one or more of the following processes; washing, peeling, coring, slicing, dicing, dipping, blanching. In other exemplary embodiments, “preparing a food item for pre-dehydration” comprises any other preparatory steps needed to prepare a food item for pre-dehydration and further processing. The exact choice of processes used will depend on the particular food item being prepared and the characteristics thereof. A person of skill will readily be able to determine an appropriate choice of processes to employ.

The term “pre-dehydration” as used herein, refers to methods of “electromagnetic drying” which are unique dehydration methods that can achieve dehydration and blanching to inactivate the enzymes, thereby minimizing or avoiding browning and quality deterioration of the finished products. In exemplary embodiments, pre-dehydration methods include drying methods that employ electromagnetic radiation including, e.g., infrared radiation, microwave radiation and radio frequency radiation. In an exemplary embodiment, “pre-dehydration” methods utilize infrared radiation e.g., infrared dry blanching.

The term “blanching” as used herein, refers to any process which when applied to fruit and/or vegetable produce slows or stops the enzyme action typically associated with browning and color and flavor changes that typically result from the uncontrolled enzyme action which is associated with untreated fruits and/or vegetables. Thus, blanching is any process which prevents the color and flavor changes that can result from the uncontrolled enzyme action associated with the enzymes present in untreated foods. In some exemplary embodiments blanching is brought about by heat treatment of fruit and/or vegetables. In some exemplary embodiments, the heat treatment comprises scalding of fruit and/or vegetables in boiling water or steam. In another exemplary embodiment, the heat treatment occurs coincident with “electromagnetic drying” processes as disclosed herein e.g., drying and blanching that occur simultaneously during infrared dry blanching.

The term “dehydration” as used herein, refers to any process by which the amount of water is reduced in a food item.

The phrase “grinding to produce a homogeneous mash” as used herein refers to reducing the size of whole fruits and/or vegetables or pieces or slices of whole fruits and/or vegetables by chopping or grinding or any other appropriate method. Thus a mash is a composition of comminuted fruits and/or vegetables reduced to small pieces or particles by pounding or abrading or other appropriate methods as known in the art.

The term “homogeneous” as used herein, refers to typically refers to a population wherein at least about 80% of the objects comprising the population are of the same type or same category or same classification. In some exemplary embodiments a population is “homogeneous” when at least about 85% of the objects comprising the population are of the same type or same category or same classification. In other exemplary embodiments, a population is “homogeneous” when at least about 86%, 87%, 88%, or 89% of the objects comprising the population are of the same type or same category or same classification. In still other exemplary embodiments, a population is “homogeneous” when at least about 90%, 91%, 92%, 93%, 94%, 95%, 96%, 97%, 98%, 99%, or 100% of the objects comprising the population are of the same type or same category or same classification.

The term “processed food” refers to food materials that have experienced treatments for obtaining desired quality, appearance and other properties.

The term “quality deterioration” of fruits and vegetables refers to changes in color or texture, or loss of phytochemicals, nutrients, and other food attributes.

The term “loading rate” refers to an amount of sample in a sample holder, or the area percentage of a sample holder covered by the samples.

The term “TPA” refers to a texture profile analysis which is used to evaluate the texture properties of foods.

### I. Introduction:

In an exemplary embodiment, the invention provides a method for manufacturing a frozen food product comprising fruits and/or vegetables that are pre-dehydrated using electromagnetic drying methods. The frozen food product retains the full or nearly full complement of fiber present in the fresh fruits and/or vegetables used in its manufacture, and provides concentrated amounts of beneficial polyphenolic antioxidant compounds and vitamin C as compared with fresh fruit and/or vegetable produce. The frozen food product thus provides a healthful form of processed fruits and vegetables, which can be conveniently consumed. Thus, the frozen fruit product promotes the consumption of fruit and vegetables, which should ultimately result in improved human health.

Frozen vegetables are important articles of commerce, being used as consumer items, industrial raw materials and in food service. Although freezing is a popular and convenient technique for preserving produce, not all fruits and/or vegetables freeze well. Indeed, strawberries and green beans, for example do not tend to respond well to freezing. Instead of retaining quality and appeal of fresh produce, juices typically leak from thawed strawberry cells and green beans tend to lose texture. Thus, some food items become unappetizing when frozen.

Fortunately, the present inventors have discovered that by using electromagnetic radiation e.g., infrared radiation, to pre-dehydrate and blanch fruit and/or vegetable food items, all fruits and/or vegetables can be well frozen. Thus, frozen fruit and/or vegetable bars can be prepared which enhance the consumption, enjoyment and health benefits associated with eating fresh fruit and/or vegetable produce.

There is great interest in improving human health through improved nutrition. In particular, increased consumption of fruits and vegetables in producing healthful, frozen whole fruit- and vegetable-based bars. Indeed, as will be apparent from the disclosure that follows, frozen whole fruit and vegetable based bars are useful for promoting and encouraging the consumption of the fruits and vegetables, and thus, are beneficial in promoting human health.

### II. Manufacturing Frozen Fruit and Vegetable Bars

A. Fruits, Vegetables and Preparation for Pre-Dehydration

In an exemplary embodiment, a frozen food product comprises fruit and/or vegetables in amounts that are in a range of between about 80% to about 100% fruit and/or vegetable. In some exemplary embodiments the frozen food product comprises fruit and/or vegetables in an amount that is about 81% fruit and/or vegetable, 82%, 83%, 84%, 85%, 86%, 87%, 88%, 89%, 90%, 91%, 92%, 93%, 94%, 95%, 96%, 97%, 98%, or 99%, fruit and/or vegetable.

The bars can be any convenient shape or size. For example a rectangle, square, circle, oval etc. In some exemplary embodiments, the bars are sized to provide the US RDA of particular nutrients.

(i) Fruits and Vegetables

Exemplary fruits and vegetables include, but are not limited to bright orange vegetables e.g., carrots, sweet potatoes, pumpkin, tomatoes and tomato products, red sweet pepper etc. Green vegetables e.g., spinach, collards, turnip greens, kale, beet and mustard greens, green leaf lettuce, broccoli, peppers, cabbage, brussels sprouts, peas etc. Orange fruits e.g., mango, cantaloupe, apricots, and red or pink grapefruit etc. Citrus fruits and juices, kiwi fruit, strawberries, guava, papaya, oranges, bananas, plantains, honeydew melons

(ii) Preparation of Fruits and Vegetables for Pre-Dehydration

Fruits and/or vegetables are prepared for pre-dehydration using any one or more of the following processes, all of which are well known in the art (see e.g., Desrossier, N W, The technology of food preservation, The AVI Publishing Company, 1965) washing, peeling, coring, cutting, dicing, slicing, dipping, and/or blanching.

Blanching is any process which inactivates either partially or fully the enzymes responsible for enzymatic browning and color and flavor changes that typically occur due to the uncontrolled enzyme action associated with untreated fruits and/or vegetables. Blanching is well known in the art (see e.g., U.S. Pat. Nos. 6,004,601; 5,932,266; 4,521,439). Enzymatic browning of fruits and vegetables creates heavy economic losses for growers.

In some exemplary embodiments blanching is undertaken by the application of heat treatment prior to pre-dehydration. It is well within the abilities of the person skilled in the art to provide heat treatments and blanching methods which are suited to the stated purpose, the precise details of which will depend on the nature and size of the fruit and/or vegetable concerned.

In some exemplary embodiments, blanching takes place as part of the pre-dehydration process e.g., during infrared irradiation. Indeed, in one exemplary embodiment, infrared radiation is used to achieve simultaneous blanching and dehydration of fruits and vegetables with high product quality.

In some exemplary embodiments, enzymatic browning is controlled with chemicals, e.g., by dipping the fruit and/or vegetable in a solution that slows or stops the enzyme action responsible for the enzymatic browning. In one exemplary embodiment, a food item comprising a fruit and/or vegetable is dipped in lemon juice and/or other acids are used to preserve color in the fruit and/or vegetable. In another exemplary embodiment, a food item comprising a fruit and/or vegetable is dipped in a solution containing 0.5% ascorbic acid and 0.5% sodium chloride. In another exemplary embodiment, a food item comprising a fruit and/or vegetable is dipped in a solution containing 0.5% ascorbic acid and 0.5% sodium chloride for 5 minutes. In some exemplary embodiments, dipping in a chemical solution takes place before blanching and/or partial dehydration.

B. Pre-Dehydration

Fruits and vegetables typically have high water contents resulting in products that are hard to bite after they are frozen, and which therefore can not be conveniently consumed. The available frozen fruit bars on the market are normally made with concentrated fruit juices. In the production of the concentrated juices, the water soluble nutrients and fiber are removed resulting in loss of health promoting nutrients and natural products. Fortunately, by treating a fruit and/or vegetable item with electromagnetic radiation e.g., using infrared dry blanching processes, it is possible to produce a fruit and/or vegetable food item that has the fiber and nutrients characteristic of whole fruits and/or vegetables and which can be frozen and subsequently enjoyed as a snack or desert, or in any convenient time and place, thereby helping people to achieve healthier and better living and prevent and reduce obesity.

Typically, pre-dehydration comprises treating a fruit and/or vegetable food item with electromagnetic irradiation. Electromagnetic drying to pre-dehydrate the fruit and/or vegetables comprising the frozen food product results in a flavorful product having concentrated fruit and vegetable nutrition. Exemplary electromagnetic radiation for pre-dehydrating fruit and/or vegetables includes e.g., infrared, microwave, and radio frequency.

(i) Infrared Drying/Dry Blanching

In an exemplary embodiment, infrared radiation is used to pre-dehydrate the fruit and/or vegetables. The use of infrared radiation for the blanching and dehydration of fruits and vegetables is disclosed in co-pending 10/917,797, filed Aug. 13, 2004 (U.S. Patent Application publication 200600334981) and is referred to herein as infrared dry blanching. Thus, in an exemplary embodiment, infrared dry blanching is used to pre-dehydrate fruits and/or vegetables.

Since infrared dry blanching does not involve the addition of steam or water in the process of blanching, it is referred to herein as “infrared dry-blanching” (IDB) technology. In an exemplary embodiment, infrared dry blanching is used to perform simultaneous blanching and dehydration of fruits and/or vegetables in a method for preparing a frozen food product.

In an exemplary embodiment, pre-dehydration of fruits and/or vegetables is carried out using IDB technology. In some exemplary embodiments, IDB is combined with heated air or vacuum to accelerate the drying process. Vacuum typically enhances heat penetration, thus making the blanching process itself more effective. Typically, when using vacuum, the vacuum he vacuum is in the range of between 20-30 inches Hg. In one exemplary embodiment, the combined infrared and vacuum process improves the texture and appearance of the finished products.

In general, pre-dehydration using infrared dry blanching provides uniform heating which enhances energy efficiency and limits damage from over-heating. Pre-dehydration using infrared dry blanching also permits zone heating to address differential density and is a safe, non-toxic process with no harmful side-effects to humans or the environment.

Because infrared penetrates food materials without heating the surrounding air IDB technology is inherently energy efficient. Fruits and/or vegetables pre-dehydrated using infrared dry blanching can be blanched and dried in a single step and retain the nutrients, phytochemicals, and flavors characteristic of whole fruits and/or vegetables.

IDB technology typically utilizes medium and far infrared radiation (IR) to perform blanching, dehydration/drying, and simultaneous blanching/dehydration of food, e.g., fruits and vegetables. IR radiation effectively transfers energy (heat) and penetrates food products, driving off naturally present moisture and inactivating quality-degrading enzymes. It can be combined with heated air to accelerate the drying process and can be used to produce many kinds of convenient dried, refrigerated, frozen and dehydrofrozen products such as fruits and vegetables.

IDB has much higher energy efficiency compared to steam blanching, and produces results equal to or better than steam blanching. The energy consumption of conventional food driers using hot air varies from 4 to 10 MJ/kg (1,720 to 4,300 BTU/lb) of water evaporated (Leniger and Beverloo (1975) Food Process Engineering. Dordrecht, Holland, D. Reidel Publisher. Co. p552). Ginzburg ((1969) Application of Infrared Radiation in Food Processing. London) reported that infrared drying could save energy up to 38% for drying a sample fruit such as apple. In other words, IDB represents a significant advance in energy efficiency, satisfying a long-felt need.

The early attempts of using infrared for blanching of celery and apples as pretreatment for freezing and peeling were reported by Asselbergs and Powrie (1956) Food Technology, 10:297; and Asselbergs et al. (1959) Quick Frozen Foods. 21:45. However, the use of only infrared for blanching was not successful because of high expense as well as technical difficulties related to controlling the process.

Recently, new and improved infrared heaters or emitters with appropriate wavelengths have been developed, which makes the application of the technology to food and agricultural processing possible. The new and improved heaters or emitters with appropriate wavelengths provide much more control, permitting more specific and precise treatment of food and agricultural products.

Infrared radiation energy can be generated by converting thermal or electric energy to infrared radiation energy. Various infrared emitters have been developed: catalytic, electric, carbon, and ceramic. IR emitters work by transferring a large amount of thermal energy to both the surface and interior of the food product being processed. This radiation energy heats the product to a target temperature in order to achieve blanching and drying simultaneously.

Infrared radiation itself is energy in the form of a band of invisible light or electromagnetic wave. Depending on specific wavelength range, infrared energy generally is divided into the following categories: near infrared (0.8-2 μm), medium infrared (2-4 μm) and far infrared (4-100 μm). Molecular (chemical) bonds, present in all substances, evince certain physical phenomena such as vibrational and rotational frequency. IR radiation is able to excite or increase the vibrational or rotational frequency of these bonds, thereby generating heat in the product being treated.

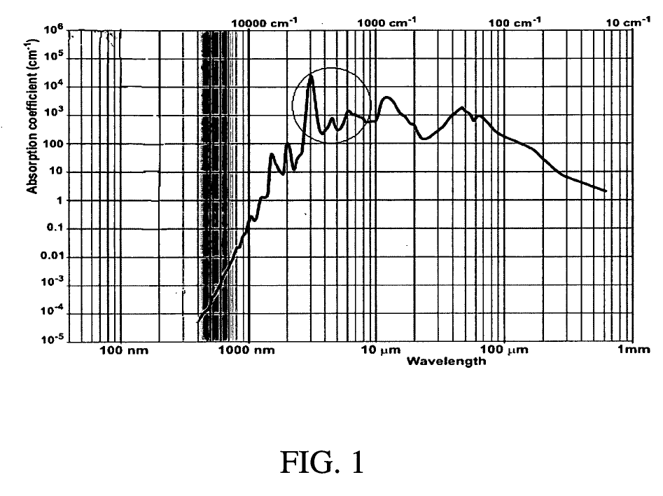

The molecular bonds in water absorb energy efficiently and become heated especially when subjected to medium and far IR radiation, with peak wavelengths at 3, 4.7, and 6 microns. See FIG. 1. For wavelengths beyond 10 μm, the radiation energy is too low to be used for heating and thermal processing. This means IDB requires use of medium and far IR, at values generally below 10 μm.

Since many (most) unprocessed food products contain water, it is possible to use the IR energy spectrum that is effective at heating water in order to achieve blanching and dehydration of the food product itself. Moreover, since infrared energy in the medium and far wavelengths does not heat the air and surrounding medium, energy transfer is highly efficient. Therefore, infrared radiation can be used to blanch and reduce the moisture content of food products at faster rates without exposing them to the damage-inducing high temperatures of conventional steam or hot water blanching and convection drying.

The penetration capability or “transmissivity” of infrared depends on the physical and chemical characteristics of the products to be treated. Soft fruits and vegetables, for example, permit IR radiation to penetrate to a depth of about 10 mm (Pierce, 1998; Ginzburg, 1969).

C. Freezing and Molding Pre-Dehydrated Fruit and Vegetables

Typically, water activities of fruits and vegetables are lowered using various methods, including e.g., drying and osmotic processes. The formed fruit and vegetable bars are then frozen to produce frozen fruit and vegetable bars with high nutritional value, which still maintain the characteristics of whole fruits and vegetables.

(i) Partial Dehydration Through Drying

In an exemplary embodiment, the pre-dehydrated fruit and/or vegetable is further dehydrated by any method known in the art e.g., infrared, microwave, and radio frequency, hot air etc. Dehydrating lowers the moisture content and water activity of the fruits and vegetables.

(ii) Reforming/Restructuring

In an exemplary embodiment, before forming fruit and vegetable bars, the sizes of partially dehydrated fruit and/or vegetable pieces are reduced. Reforming and restructuring are carried out by any method known in the art e.g., chopping, slicing, pureeing.

(iii) Freezing

In an exemplary embodiment, before forming the bars, the partially dehydrated fruit and/or vegetable pieces are mixed with nuts, e.g., almonds, walnuts. In another exemplary embodiment, the partially dehydrated fruit and/or vegetable pieces are fortified with nutritional supplements, e.g., calcium, vitamins. In still another exemplary embodiment, the formed bars are coated with chocolate and/or other confectionary coatings. The amount of other ingredients e.g., nuts, vitamins, coatings etc, can be present in any convenient or useful amount. Typically however, these other ingredients do not exceed 20% of the frozen food product. In some exemplary embodiments other ingredients are present in an amount that is in a range that is between about 0.01% and 20%. In other exemplary embodiments, other ingredients are present in an amount that is about 0.5%, 1%, 2%, 3%, 4%, 5%, 6%, 7%, 8%, 9%, 10, 11%, 12%, 13%, 14%, 15%, 16%, 17%, 18%, 19%, or 20% of the frozen food product.

(iv) Water Content and Water Activity

Water content and water activity influence the hardness and texture of the frozen fruit product disclosed herein. As is known in the art, moisture content is the amount of water held by a food. Water activity on the other hand, is the amount of free water in a food product and is a reflection of the amount of water in a product which is available for chemical and biological reactions. Moisture content is related to water activity in a non-linear relationship known as a moisture sorption isotherm curve (see e.g., Encyclopedia of Agricultural, Food, and Biological Engineering, Dennis R. Heldman, Ed., CRC Press, 2003).

Appropriate water activity in partially dehydrated fruits and vegetables ensures good binding between the pieces of fruits and vegetables during formation and freezing of the bars. It also provides desirable texture or hardness to the frozen bars.

a. Water Content

Water or moisture content is measured by methods known in the art (see e.g., AOAC (1990). Official methods of analysis (15th ed.). Association of Official Analytical Chemists, Arlington, Va. and Encyclopedia of Agricultural, Food, and Biological Engineering, supra). Typically, samples to be analyzed are oven dried, under specified conditions, and the loss of weight is used to calculate the moisture content of the sample.

In an exemplary embodiment, drying is conducted under reduced pressure (20-100 mm Hg) to allow for a more complete removal of water and volatiles without decomposition of the sample. In another exemplary embodiment, the moisture content of the samples before and after pre-dehydration is determined using 2 g samples dried for 12 h at 70±1° C. under pressure 20 in.Hg in Lindberg/Blue vacuum oven (Waltham, Mass.) (AOAC 934.06).

b. Water Activity

As noted above, water activity is a measurement of the amount of water available for chemical reactions in foods, e.g., microbiological spoilage, hydration of colloids, enzyme activity, etc. As is known in the art, a higher value of water activity signifies that a higher amount of free water is available relative to a lower value (see e.g., Water Activity in Foods: Fundamentals and Applications, Gustavo V. Barbosa-Cánovas, et al. Eds. Blackwell Publishing 2007). Water activity is influenced by a number of factors including, but not limited to the amount and types of solids present in the food and the interaction of the solids with the water. Thus, even if two foods contain the same moisture content (i.e., water content), the water activity can be different if the solid compositions of the foods are different.

Water activity is related to the water content in the foods in a non-linear fashion according to the equation:

a_{w}=P/P₀

wherein “a_{w}” is the water activity and where P is the vapor pressure of the food and P₀ is the vapor pressure of water at the same temperature.

Water activity is measured using methods known in the art (see e.g., Gustavo V. Barbosa-Cánovas, et al. supra). In an exemplary embodiment, water activity of thawed frozen fruit bars is determined using an Aqualab CX-2 a water activity meter (Decagon Devices, Pullman, Wash.).

Typically, hardness, which is measured by any method known in the art (e.g., Instron hardness) decreases with decreased water content and especially with decreased water activity. Thus, control of the hardness of a frozen food product is achieved by controlling the water activity of the final frozen food product. Typically, a frozen food product has a water activity that is between about 0.90 and about 0.98. In some exemplary embodiments, a frozen food product has a water activity that is between about 0.91 and about 0.97. In still other exemplary embodiments a frozen food product has a water activity that is about 0.97, about 0.96, about 0.95, about 0.94, about 0.93, or about 0.92.

The following examples are offered to illustrate, but not to limit the invention.

### EXAMPLES

### Example 1

The following Example, Experiments 1-5, illustrate various aspects of infrared dry blanching methodology.

A Catalytic flameless gas-fired (CFG) infrared emitter from Catalytic Infrared Drying Technologies LLC (Independent, Kans.) was used for these experiments. Other types of infrared emitters or heaters may also be used to generate the required medium and far infrared radiant energy. For comparison, control samples were produced by using a steam blancher and conventional heated air dryer. Various food products such as pears, baby carrots, cut sweet corn and sliced potatoes were used in these experiments to study the effectiveness of IDB.

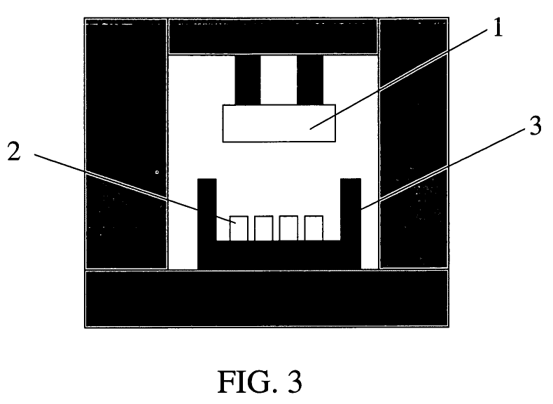

The CFG infrared emitter used for these experiments generated medium and far IR with peak energy from 3.3 to 8 microns, utilizing catalyzed natural gas. A schematic of how the emitter was set up to function as an infrared blancher/dryer is shown in FIG. 3. When combined with air across the catalyst, natural gas reacts by oxidation-reduction to yield a controlled bandwidth of infrared energy. Small amounts of CO₂ and water vapor are also produced. The unique feature of this process is that the radiant energy bandwidth generated is in the medium and far infrared range with wavelengths ranging from 3.3 to 8 microns, which can be used quite effectively to target water molecules in the food products to be processed. Compared to short wavelength infrared (<2 μm) used for other applications, the relatively long wavelength used in these experiments provided the unexpected result of higher heat penetration capability.

The wavelength and total emitted energy were controlled by varying the gas supply which in turn controlled the temperature of the infrared emitter/heater. Controlling the temperature is critical—if the temperature is too low, the total emitted energy can not meet the heating requirement. If the temperature was elevated above ignition point, 600° C., the natural gas ignited, thus destroying the samples as well as causing safety concerns. To achieve desired emitter/heater temperature, the natural gas supplied to the infrared heater was measured with a flow meter at various flow rates. In order to achieve the desirable wavelength and required energy for processing fruits and vegetables, the emitter/heater was operated at a temperature of 150-600° C. (Table 1).

TABLE 1
Relationship of blackbody emitter surface temperature
to peak wavelength (microns)

| 150° C. | 250° C. | 350° C. | 450° C. | 550° C. | 600° C. |
|---|---|---|---|---|---|
| 6.8 | 5.5 | 4.6 | 4 | 3.5 | 3.3 |

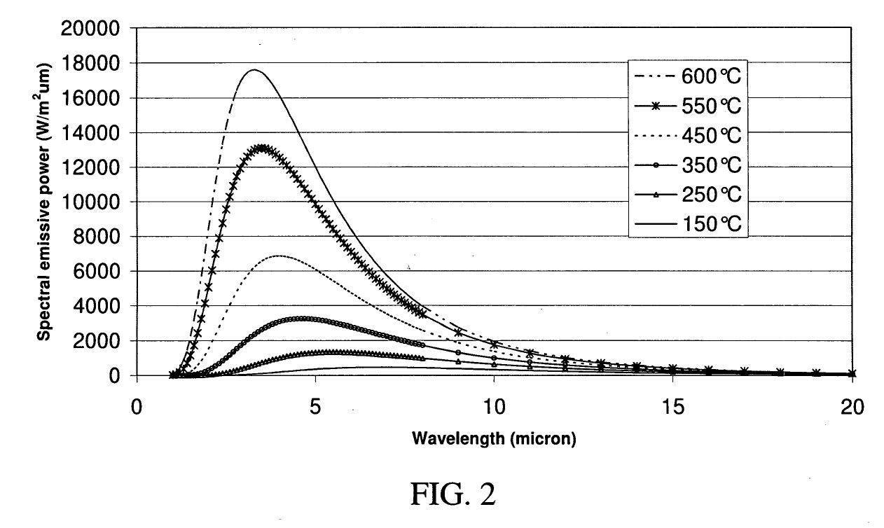

The energy emitted at different emitter/heater temperatures is shown in FIG. 2.

Controlling the emitter was also achieved through use of a microcomputer linked by sensors and probes to the food products being tested. Commercially available software is available to assist this process, such as that available through Labview of National Instruments (Austin, Tex.).

Four types of fruits and vegetables, including pear, carrot, potato and sweet corn were used for blanching and dehydration tests. The samples were obtained from local food suppliers and stored in a refrigeration facility at 0-2° C. before being used in the experiments. Whole baby carrots, cut sweet corn, and sliced potatoes (French fries) were used only for the blanching experiments. Pears were used for both the blanching and dehydration tests. Sweet corn was cut from the cob before blanching which resulted in less energy being used for blanching since there was no need to heat the cob.

Blanching and drying tests were performed at various operating conditions and parameters to examine their effects on enzyme inactivation, quality degradation, processing time, and energy consumption. The sample weight changes at each processing step were also measured.

The inactivation of peroxidase is normally used as an indicator of blanching effectiveness. The presence of peroxidase was determined by use of both qualitative and quantitative methods. The two methods were described by Dauthy (1995) Fruit and vegetable processing. FAO Agricultrual Services Bulletin No. 119. and Reuveni et al. (1992) The American Phytopathological Society. 82(7):649-753, respectively.

For qualitative determination, the processed products were cut into two pieces right after their removal from the heater/dryer. A solution of 1% guaiacol and 1% hydrogen peroxide was applied to the cut surfaces and a check for discoloration was performed after 5 min. The color of samples was compared with the control samples that were not blanched. The absence of reddish discoloration indicated that enzymes were inactivated (conversely, the presence of reddish discoloration indicated that there was still some enzymatic activity). For quantitative determination, soluble peroxidase was extracted by blending 25 g of the sample material with 75 ml water for 1 min. Then the solution was filtered through a coarse filter paper and the filtrate was mixed with 5 ml guaiacol peroxidase buffer (0.5%). The mixture was immediately poured into a cuvette and placed in a spectrophotometer to measure the absorbance at 420 nm every 30 seconds. The slope of the resulting regression line of absorption over time defined the reaction rate.

### Experiment 1

### Blanching Pears

Infrared Dry Blanching (IDB) was compared to conventional steam blanching. Pears were used in the first comparison. Test parameters included energy efficiency, weight reduction (through dehydration), enzyme inactivation, time needed to inactivate enzymes, and final product quality.

Recently-harvested Bartlett pears were diced into approximately half-inch cubes and all samples were dipped in ascorbic and citric acid solution with specified concentration and time periods (See experiment 3) before the blanching and dehydration, which was to prevent oxidation from occurring.

To determine a benchmark blanching time with steam, samples of pear cubes were blanched for times ranging from 30 seconds to 10 minutes with 75° C. steam. After each sample was blanched for the appointed time, it was cut into two pieces and tested for enzymatic activity, using as a control a sample that had not been subjected to blanching. In particular, each sample was examined for peroxidase activity by exposing it to a solution of 1% guaiacol and 1% hydrogen peroxide. Samples blanched for less than 5 minutes showed significant red color, which indicated that the enzymes were not completely inactivated. Therefore, minimum acceptable blanching time to achieve complete inactivation of enzymatic activity, using 75° C. steam, was determined to be 5 minutes. This was the benchmark used for later comparative tests.

Using an emitter temperature of 500° C., and a distance of 115 mm between the emitter and the sample, pear cubes were subjected to IDB treatment periods ranging from 30-120 seconds. The enzymatic activity of each sample was examined, as explained above. The results showed that enzymatic activity ceased after an IDB treatment of 2 minutes.

For blanching using infrared emitters, it was shown that the enzymes in the pear sample could be completely inactivated in approximately 2 minutes, with the product placed an optimal distance of 115 mm from the emitters which were being operated at an optimal temperature of 500° C. and which correlated to a wavelength of 3.7 μm.

The samples were tested for enzyme activity. None was found, a result which confirmed the viability of IBD and infrared blanching technologies.

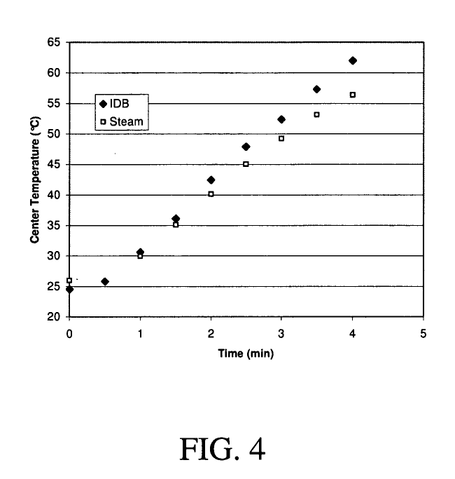

The results also indicated that less time was needed to perform blanching using IDB compared to steam blanching. This was apparently due to the fact that the heating rate of IDB was higher than that of steam blanching (FIG. 4). Heating rate is defined as temperature increase per unit time, and is an indicator of how quickly heat penetrates a sample and raises its internal temperature. A higher heating rate suggests faster heat penetration.

To determine and compare the heat transfer rate, or “heating rate,” of IDB and steam blanching, two different tests were conducted. The first test involved using pear cubes; the second test involved pear slices.

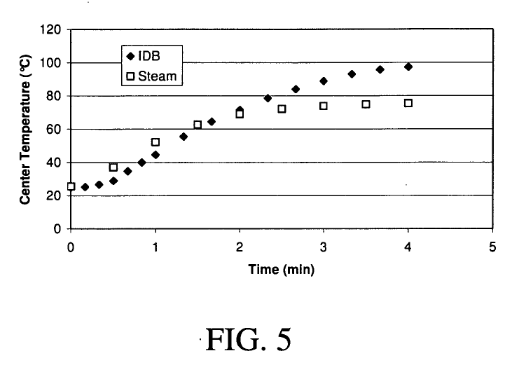

Pear cubes, approximately 13 mm on a side, were blanched with IDB using an emitter set at 500° C., and set at a distance of 115 mm from the samples. Pear cubes were also blanched using steam at 75° C. The heating rate of each is shown in FIG. 5. The center temperature of the samples was measured by using thermal couples placed at the geometric center of each sample. Approximately 2 minutes elapsed for the center temperatures to reach 70° C. for both IDB and steam blanching. After two minutes, the center temperature of the steam blanched sample approached an equilibrium temperature of 75° C. The temperature in the center of the sample being treated by IDB, however, continue to rise to nearly 100° C. after 4 minutes. While it is unnecessary to increase the temperature beyond 75° C. in order to achieve inactivation of enzymes, higher temperatures may be helpful if dehydration is part of the intended processing.

Pear slices, cut to a thickness of approximately 13 mm, were also tested for heat transfer rate using both IDB and steam blanching. The samples were placed in an aluminum sample holder (baking pan) inside the catalytic flameless gas-fired (CFG) infrared blancher/dryer with emitter surface temperature at 500° C. The sample holder surface was 115 mm from the emitter surface. The heating rate of pear samples with the same dimensions was also measured under steam blanching at 75° C. The samples being treated by IDB absorbed heat more quickly, showing a more rapid rise in internal temperature and therefore revealing a more efficient heat transfer rate. See FIG. 4. Since a higher heat transfer rate can result in a shorter processing time, less time is needed to inactivate enzymes using IDB compared to conventional steam blanching.

Although FIG. 4 shows that there is an inherent superiority to IDB over steam blanching in terms of time efficiency and heat transfer rate, the difference is actually greater than what is shown. The test that was conducted applied IDB heat from only one side, while steam blanching envelops a sample from all sides. If the IDB test had been performed using infrared emitters placed above or below samples, or if the samples had been placed inside a rotating drum for example, the heating rate would have undoubtedly been further increased. In other words, uniform heating from all surfaces could further reduce the time needed for blanching to inactivate the enzymes using IDB.

The experimental data also showed that a 6.7% weight reduction occurred after the 2 min IDB treatment. This weight reduction was primarily caused by moisture removal from the sample surface. If minimal moisture removal is desired during the blanching process, high loading rate or an enclosed sample chamber could be used for minimizing the water loss. The reduced moisture at the surface of the samples could also offer certain advantages to dehydrofrozen foods which are traditionally processed by first blanching then drying and finally freezing the foods.

### Experiment 2

### Blanching and Dehydration of Pears using IDB

Pear samples were also subjected to a dehydration study. The conventional method of dehydrating pears is to subject them, after steam blanching, to hot, forced air in order to drive off water vapor. Since steam blanching cannot be used for dehydration processing and IDB can, IDB has a distinct advantage since it can both blanch and dehydrate in a single step.

For this experiment, fresh (wet) pear samples were dehydrated using both conventional hot air drying and IDB. Dehydration was conducted until a 50% weight reduction was achieved. The drying rates and weight losses of pears were determined using an automatic weight data acquisition system developed in the researchers' laboratory.

The temperature setting of the IDB emitter was critical to the outcome of the test. The surface temperature of heater/emitter was measured by using temperature sensors preinstalled in the emitter. The optimum conditions for achieving blanching followed by dehydration (until a 50% weight reduction of the sample was achieved) were as follows: an emitter temperature of 500° C. for the first 2 min at a distance of 115 mm from the sample (radiation energy intensity of 5.7 kW/m²) between sample holder surface and emitter, followed by a temperature reduction to 470° C. and an increase in the emitter distance to 265 mm (radiation energy intensity of 2.7 kW/m²).

The changes in temperature and distance combined to reduce the energy (heating) intensity during the second stage of the treatment—the dehydration stage. This reduction in heat intensity was necessary in order to avoid or minimize any deterioration of product quality in terms of texture and color development. In other words, for IDB (dehydration) applications lasting longer than 2 minutes, it might be helpful to reduce the heat supply in order to maintain both sufficient heating and also to reduce the likelihood of degrading the product.

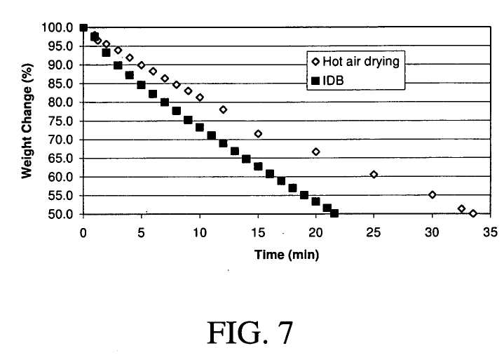

For studying the dehydration rate of infrared processing, the sample weight change was monitored and recorded with an electronic balance and data acquisition system. The control samples were blanched with 75° C. steam for 5 min before being dried with forced heated air at velocity of 1.2 m/s and 70° C. The weight change of the samples in the heated air drying was also monitored and recorded with electric balance. The results showed that the IDB reduced the required dehydration time from 33.5 min of hot air drying to 21.6 min of IDB when 50% weight reduction was achieved (FIG. 7). This was a 35.5% time reduction or improvement of processing efficiency. Meanwhile, the IDB method combined two processing steps, blanching and dehydration, into one, but the hot air drying (conventional drying) needed an additional blanching step which would require 5 min. The total time of steam blanching and hot air drying was 38.5 min. This indicated at least 43.9% reduction of processing time by IDB compared to the existing blanching and dehydration technologies. Therefore, the improvement of processing efficiency was significant.

Energy usage was also monitored during the blanching/dehydration process. When 367 g of pear sample was blanched with IDB method for 2 min, a total of 0.014 m³ of natural gas or 5,323 kJ of energy (assuming 37260 kJ/m³) was used, which was obtained by measuring the gas flow rate. If the specific heat of the pear was assumed to be 3.45 kJ/kg° C., and the sample temperature was increased from 20 to 70° C., the energy used for the heating was 65.9 kJ. Therefore, the energy efficiency of IDB for blanching was 12.4%. However, the energy efficiency of commercial steam blanching was only about 3% (Bomben. 1977). Clearly, the energy efficiency of IDB was much higher than commercial steam blanching. Meanwhile, in the calculation, the energy used for dehydration was not counted. If the product needs to be dehydrated after blanching, the overall energy efficiency will be even higher. At the same time, the obtained energy was based on a small infrared blancher/dryer which has much lower energy efficiency than potential large commercial blanche/dryer. Therefore, it is concluded that IDB is an energy efficient technology for blanching and dehydration.

Assays were also conducted wherein the food product was subjected to a two-stage process. The first stage involved exposing the food item to a fixed temperature for a fixed period, followed by a second period of exposure at a different temperature. This permitted the blanching to be achieved, primarily during the first stage, and for the dehydration to occur in the second stage, generally at reduced temperature which operated to achieve the desired result but without causing unnecessary degradation to the food product.

### Experiment 3

### Pretreatment

It was also discovered that the blanching process can be made more effective with a “pretreatment” applied to the fruits and vegetables before IDB. In fact, without such a pretreatment, some samples turned dark before and after the blanching and dehydration process due to oxidation. This discoloration could also occur during the thawing process of dehydrofrozen samples even if the enzymes in such samples had been inactivated. Two solutions were used for the pretreatment study: 1% ascorbic acid, and a combination of 1% ascorbic acid and 1% citric acid.

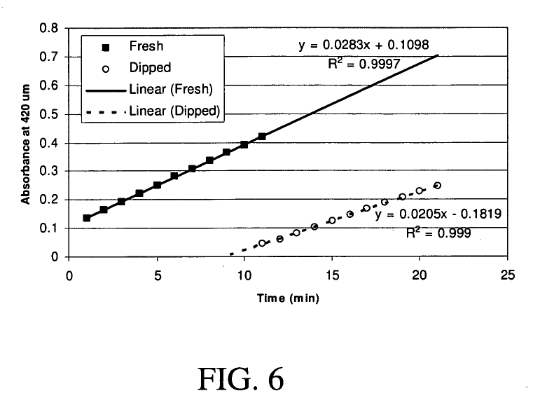

To conduct this experiment, pears were cut into cubes with dimension of 12.7 mm and held in the solution for various times, from 4 to 30 min. The control sample was not dipped in the solution. Then the samples were left in the room for at least 10 min to observe the color change. It was observed that the control sample turned dark quickly, but, in general, the treated samples kept a bright color before blanching (FIG. 6). As absorbance increased, the discoloration became more noticeable.

After the dipped and control samples were blanched with 75° C. steam for 5 min and left in the room for 20 min, a color difference between the samples was noticeable. A similar color change was also observed with samples treated with IDB. Pretreatment significantly reduced this darkening which was caused by oxidation. Samples treated with 1% ascorbic acid were darker than the samples treated with a combination of 1% ascorbic acid and 1% citric acid. This was observed after the samples were exposed to air for 2.5 hr after blanching. When the sample was dipped for 30 min with the combined acid solution, the sample showed no oxidation. Therefore, it was possible to prevent oxidation by pretreating pear samples before blanching with a combined solution of 1% ascorbic acid and 1% citric acid. Based on these results, the samples used for this research were pretreated with the combined solution for 30 min before blanching.

Some fruits and vegetables, however, are not very sensitive to oxidation and may not need the pretreatment or may only need light dipping treatment (low concentration and/or short time). Carrots are an example.

### Experiment 4

### Texture, Color, and Nutrient Preservation

The texture of IDB blanched and dehydrated pear cubes (50% weight reduction) was measured using Instron (5500R mainframe, Merlin Software) following the Texture Profile Analysis (TPA) methods described by Brown (1977) Journal of Texture Studies. 7:391-404. In this test, fracturability, hardness, cohesiveness, adhesiveness, springiness, gumminess, and chewiness of the samples were determined. The control used was produced with steam blanching (75° C.) and hot air drying (70° C.). The TPA methods used two measuring cycles. The two downward cycles compressed the pear piece 60% of the entered height at a rate of 15 mm/min. The two upward cycles returned the platen to its original position at a rate of 25 mm/min. The load cell was 100 N and the platen was 25 mm in diameter. The results of this test showed that samples produced with IDB tended to have higher firmness than the control.

The color and reflectance of blanched and dehydrated pear pieces were measured using a Minolta Spectrophotometer. The Minolta Spectrophotometer simultaneously measured the color and reflectance and then the data were downloaded into a computer. The color values of L a b were measured. The sample used for color measurement included frozen pears, frozen pears which had been thawed in the open air for 2 hours at 23° C., and those thawed in de-ionized water for 1 hour at 23° C. (rehydrated samples). The results of this test showed no significant difference between samples processed with IDB and steam blanching plus hot air drying.

Rehydration is important because some food applications must have high moisture content. One way to measure rehydration is to use the “rehydration ratio” which is defined as the ratio of sample weight after rehydration and before rehydration. The rehydration ratio was measured using five pieces of dehydrofrozen pears. Each pear piece was rehydrated in deionized water by placing it into a 50 mL beaker containing 20 grams of water for one hour at room temperature (23° C.). After one hour, each piece was placed on a piece of paper towel for 1 min to remove the excess water before the sample weight was determined. The test results indicated that there was no significant difference between samples processed with IDB and those processed with steam blanching and hot air drying.

Ascorbic content was used as a nutrition quality indicator in the study since it is directly related to thermal processing conditions. It was measured by following the procedure described by Loeffler and Ponting (1978). The final ascorbic content was reported based on dry solid basis. The results indicated that the samples processed with IDB had higher ascorbic content than those processed with steam blanching and hot air drying.

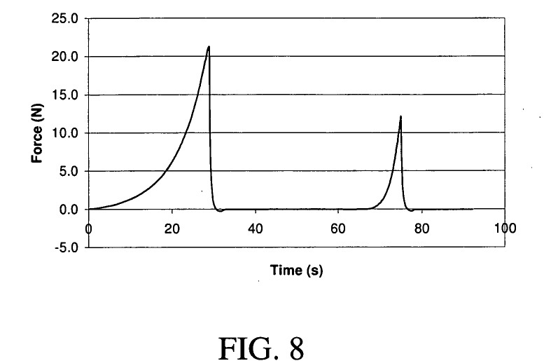

The typical TPA curve of blanched and dehydrated pear is shown in FIG. 8. The detailed definitions and calculation methods for fracturability, hardness, energy area, cohesiveness, adhesiveness, springiness, gumminess and chewiness were adopted from Bourne (1978). From the texture measurement results, it was apparent that the sample processed with IDB was firmer than the samples processed with steam and hot air (See table 2 below). This was also observed with sensory evaluation during the experiment. The samples processed with IDB tended to have cleaner flavor compared to traditional methods. The texture results indicated that IDB technology produced products with superior texture compared to those produced by existing technology.

TABLE 2
Texture characteristics of pear processed with IDB and conventional method

| | | | | Energy | | Energy | | | | | |
|---|---|---|---|---|---|---|---|---|---|---|---|
| | | | | (MJ) | | (MJ) | | | | | |
| | | | | area of | Hardness | area of | Cohe- | | | | |
| Sample | | Fracturability | Hardness 1^{st} | 1^{st} | 2^{nd} Peak | 2^{nd} | siveness | Adhesiveness | Springiness | Gumminess | Chewiness |
| Name | Sample # | (N) | peak (N) | peak | (N) | peak | (ratio) | (MJ) | (mm) | (N) | (N) |
| IBD | Average | 18.3 | 18.3 | 20.7 | 12.6 | 4.1 | 0.20 | 0.41 | 1.55 | 3.73 | 5.76 |
| | S.D. | 7.7 | 7.6 | 8.9 | 5.0 | 1.6 | 0.02 | 0.18 | 0.09 | 1.57 | 2.42 |
| | High | 33.9 | 33.9 | 39.9 | 22.5 | 7.3 | 0.24 | 0.75 | 1.69 | 6.23 | 9.63 |
| | Low | 9.6 | 9.6 | 10.1 | 6.8 | 2.1 | 0.16 | 0.24 | 1.45 | 2.01 | 3.11 |
| | Range | 24.3 | 24.3 | 29.8 | 15.7 | 5.2 | 0.08 | 0.51 | 0.25 | 4.23 | 6.53 |
| CD | Average | 13.1 | 13.1 | 14.2 | 9.0 | 3.2 | 0.23 | 0.38 | 1.68 | 2.91 | 4.83 |
| | S.D. | 4.8 | 4.8 | 5.8 | 3.1 | 0.9 | 0.03 | 0.14 | 0.20 | 0.73 | 0.94 |
| | High | 24.9 | 24.9 | 29.3 | 17.0 | 5.4 | 0.28 | 0.60 | 2.10 | 4.61 | 6.91 |
| | Low | 8.5 | 8.5 | 8.9 | 6.2 | 2.3 | 0.19 | 0.21 | 1.48 | 2.06 | 3.70 |
| | Range | 16.4 | 16.4 | 20.4 | 10.8 | 3.1 | 0.10 | 0.39 | 0.63 | 2.55 | 3.20 |

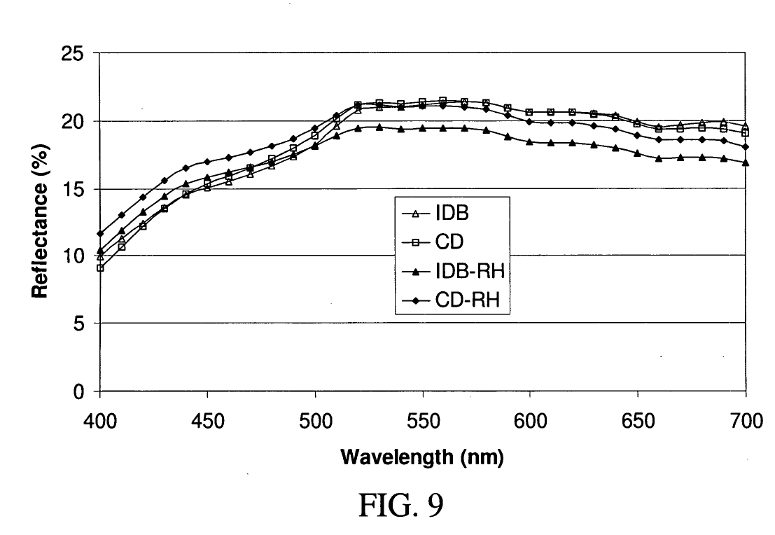

The color changes of pear samples processed with IBD and those processed by the conventional method of steam blanching and hot air drying are shown in Table 3 below. In general, no significant difference between blanched and dehydrated samples processed with different methods was observed even though it seemed that samples darkened slightly during thawing and rehydration based on the color data. After the blanched and dehydrated pear samples were rehydrated and thawed, however, the product appeared to become brighter due to the increased translucence as indicated by the lowered reflectance (FIG. 9). When the hydration ratios of pear samples processed with IDB and conventional methods were examined, no significant difference was found.

TABLE 3
Color change of pear samples processed with different methods

| | Frozen | | | Thawed | | | Rehydrated | | |
|---|---|---|---|---|---|---|---|---|---|
| Samples | L | a | b | L | a | b | L | a | b |
| IDB | 56.5 ± 2.4 | −3.8 ± 0.4 | 12.0 ± 1.6 | 54.3 ± 1.1 | −4.7 ± 0.4 | 11.1 ± 1.6 | 50.6 ± 3.9 | −3.9 ± 0.2 | 5.9 ± 0.9 |
| CD | 54.1 ± 2.9 | −4.4 ± 0.3 | 11.9 ± 3.1 | 52.6 ± 1.5 | −5.0 ± 0.4 | 11.2 ± 2.2 | 52.3 ± 2.4 | −4.4 ± 0.2 | 7.0 ± 0.7 |

Ascorbic content was used as a nutritional quality indicator. Samples were dipped and held in an ascorbic solution for 30 minutes and then measured for their ascorbic acid content. The samples were then subjected to IDB for two minutes, followed by another check for ascorbic content. It appeared that partially dehydrated products produced with IDB had higher ascorbic content compared to that produced with steam blanching and hot air drying (see table 4 below). Therefore, nutrient retention is another advantage of IDB compared to conventional steam blanching.

TABLE 4
Ascorbic content of samples various pear samples

| Samples | mg/g |
|---|---|
| Fresh cut | 0.3 ± 0.1 |
| 30 min dip | 15.0 ± 0.5 |
| Steam blanched | 9.9 ± 0.6 |
| IR blanched (2 min) | 14.8 ± 0.3 |
| 50% weight reduction with steam and hot air | 12.1 ± 1.6 |
| 50% weight reduction with IR | 13.5 ± 1.9 |

### Experiment 5

### Effectiveness of IDB for Blanching Apples, Carrots, Sweet Corn and Potatoes

The effectiveness of IDB for carrots, sweet corn and potatoes was studied with an emitter set at 500° C. and placed a distance of 115 mm from the sample holder surfaces. The enzymatic activity of processed samples was determined with qualitative methods as described before.

For baby carrot blanching, carrots with a diameter of approximately 15 mm were used. The results showed complete enzyme inactivation after 3-4 minutes of blanching and that the carrots had a very nice appearance and texture.

With the same heating conditions as used for carrots, cut sweet corn kernels were blanched for one minute and achieved complete enzyme inactivation. Since the cob of sweet corn is not heated during the IDB process, less energy is consumed compared to current steam blanching technology. The obvious effectiveness of the IDB technology for blanching carrot and sweet corn showed that IDB technology would be an excellent replacement for standard hot water/steam blanching.

Potatoes were also subjected to IDB. Rectangular potato samples (like French fries) with a cross section of 12.7×12.7 mm were blanched. Enzyme inactivity was achieved within 3.5 minutes. If a golden-brown color is desired, the sample can be kept in the blancher slightly longer. This process also showed that low fat French fries could be produced with IDB technology, offering important nutritional benefits.

### Example 2

The following Example illustrates an exemplary method for manufacturing frozen food products comprising fruit.

### Materials and Methods

Chemicals. Folin-Ciocalteu reagent and ascorbic acid were purchased from Sigma Chemical Co. (St. Louis, Mo.). Gallic acid was obtained from MP Biomedicals, LLC (Solon, Ohio). Anhydrous sodium carbonate, metaphosphoric acid, 2,6-dichloroindophenol sodium salt and sodium bicarbonate were obtained from Fisher Scientific (Houston, Tex.). Kaolin was purchased from Hochberg and Company, Inc (Chester, N.J.). Ethanol and acetic acid were obtained from Gold Shield Chemical Co. (Hayward, Calif.).

Fruit materials. Apples and strawberries were chosen for this study because of their many health-promoting attributes, especially anticancer, antiradical, and antioxidant properties, due to their high polyphenolic, vitamin and fiber content. Fresh apples (Malus domesticus Borkh variety Golden delicious) and strawberries (Fragaria variety Aromas CN209) were obtained from a local grocery store (Davis, Calif.).

Frozen bar manufacturing method. Apples were peeled, cored and sliced into about 6 mm slices with an apple peeler (Back to Basics Products, Inc, Draper, Utah). The slices were dipped in a dipping solution containing 0.5% ascorbic acid and 0.5% calcium chloride for 5 minutes to prevent enzymatic browning (see e.g., Zhu Y., and Pan Z., IFT Annual Meeting. 2005. No. 96-3). Dipped apple slices were then drained on a screen for 5 minutes and excessive surface moisture was removed by blotting with paper towels before drying.

Strawberries were washed and the peduncles were removed before slicing into 6 mm thick slices using a hand-operated slicer (Hobart Corporation, Troy, Ohio).

A single layer of fruit slices was distributed evenly on a sample tray for pre-dehydration using an infrared dehydrator equipped with two CIR emitters powered by natural gas (Catalytic Infrared Drying Technologies LLC, KS). The samples were heated from both top and bottom. Quality of the pre-dehydrated slices was improved when the center temperature of the sample slices was kept at 50° C. during heating. Temperature was monitored using an automatic data acquisition system to turn the gas on and off.

The apple and strawberry slices were heated for up to 25 minutes to achieve different moisture levels: 89.0% to 75.3% for apples and 92.7% to 75.3% (wet basis) for strawberries. The sample tray was placed on a balance to measure the sample weight in-line during the pre-dehydration. After drying, the partially dehydrated samples were kept at room temperature for about 10 minutes to permit the moisture to equilibrate between the strawberry surface and interior which provided for easy grinding.

The pre-dehydrated slices were ground into a homogeneous mash using a mini chopper (Betty Crocker, Minneapolis Minn.). The mash was placed in a 110×30×20 mm plastic molds and frozen for 72 hours at a temperature of 18° C. Three replications were conducted for each test.

The frozen bars were removed from the freezer and thawed for 30 minutes at room temperature before determining their vitamin C content, total phenolic content, water activity and soluble solids. The hardness and color of frozen bars were also measured, using methods discussed below.

Measurement of moisture content The moisture contents of samples before and after pre-dehydration was determined using 2 g samples dried for 12 h at 70±1° C. under pressure 20 in.Hg in Lindberg/Blue vacuum oven (Waltham, Mass.) (AOAC 934.06).

Measurement of vitamin C content. The vitamin C content of frozen bars and raw apples and strawberries was determined using the 2,6-dichloro-indophenol titration method (AOAC 967.21). Kaolin was added to the strawberry solution to absorb the color before the vitamin C content was determined by titration.

Measurement of total phenolic content. The total phenolic content was measured using the Folin-Ciocalteu method (Slinkard, K; and Singleton, V. L., (1997) Amer. J. Enol. Vitic. 28:49-55). A 10 g sample was weighed and mixed with 5 ml ethanol. The extract was centrifuged at 13,000 rpm for 4 minutes; then the supernatant was collected. 20 μl supernatant was mixed with 1.58 ml distilled water. Then 100 μl Folin-Ciocalteu reagent (Sigma) was added and mixed well. After waiting for 1 minute, a 300 μl of sodium carbonate solution was added and shaken to mix. The solution was kept at 40° C. for 30 minutes before the absorbance was measured at 765 nm by the Beckman DU 7500 spectrophotometer (CA, USA). Gallic acid monohydrate was used as a standard, and the total phenolic content was expressed as gallic acid equivalents (see e.g., Waterhouse, A. L., (2001) Determination of Total Phenolics, In Current Protocols in Food Analytical Chemistry, I1.1.1-I1.1.8, Wrolstad, R. E., Wiley; and Singleton, V. L., et al. (1999) Methods in Enzymology 299:152-178).

Measurement of water activity. The water activity of thawed fruit bars was determined by using Aqualab CX-2 a water activity meter (Decagon Devices, Pullman, Wash.).

Measurement of soluble solids content. Thawed samples were filtered by double-layer cheese cloth to obtain juice for measuring soluble solids with ABBE Refractometer (American Optical Corporations, Buffalo, N.Y.). The soluble solids is reported as ° Brix.

Measurement of color. The color of the frozen fruits bar was determined using a Minolta calorimeter CR-200 (Osaka, Japan) to measure Hunter L, a and b values. The color measurement was conducted at three surface locations, two close to the ends and one at the middle. The measurement was repeated three times at each location.

Measurement of hardness. The hardness of the frozen bars was determined using Instron (Norwood, Mass.) with a custom-designed probe within 1 minute after they were removed from the freezer. The probe was 2 mm in width and 50 mm in the length. The measuring speed of the probe was 15 mm/min. The peak force was used to quantify the hardness of the bars.

Statistical Analysis. The SAS 9.1.3 software (SAS Institute Inc. Cary, N.C.) was used for data analysis. Differences between variables were tested at a level of significance of p<0.05.

### Results and Discussion

When the sliced apples were dipped in the ascorbic acid and calcium chloride solutions, their moisture content was slightly increased to 90.1% from 89.0% (w.b.) due to water absorption. When the slices of apple and strawberry were dried with IR, the moisture contents were reduced quickly. The strawberry slices had a much higher drying rate than the apple slices. In 18 minutes the moisture content of strawberries was reduced from 92.7% to 70.8%; for apples the reduction was from 90.1% to about 82.5%. Thus, it takes less time to dry strawberries than apples to achieve a similar moisture content.

The decreased moisture content of the slices through IR pre-dehydration resulted in increased soluble solids and decreased water activities, as expected. The soluble solids and water activity changed almost linearly with the moisture content. However, at the same moisture content, strawberry samples showed higher water activities than apple samples, but lower soluble solids, this is presumably due to the lower sugar and higher acid content in the strawberries compared to the apples.

Total phenolic and vitamin C content decreased with increased drying time and there was a rapid loss of nutrients in the early drying stages. For example, the total phenolic content of strawberries decreased from 27.9 (mg/g d.b.) to 18.4 (mg/g d.b.) after 2.5 minutes drying. However, the losses of total phenolic and vitamin C in apple were less than the losses of total phenolic and vitamin C in strawberries, f possibly due to the higher initial concentrations of these nutrients in strawberries.

Fortunately however, despite nutrient losses during pre-dehydration, the total phenolic and vitamin C contents were increased in the final pre-dehydrated frozen products, due to concentrating effects as shown in Table 5. Indeed, for pre-dehydrated strawberries, the concentrations of total phenolic and vitamin C increased by 115.2% and 157.9%, respectively, when dried from 92.7% to 70.8% moisture. For the pre-dehydrated apples, the concentration of total phenolic and vitamin C also increased by 54.6% and 16.0%, respectively—when they were dried from 90.1% to 75.3% moisture. Thus, more nutrients can be obtained from a given amount of pre-dehydrated frozen bars than from the equivalent amount of fresh products.

After dipping the apple slices, soluble solids content was reduced from 10.9 to 9.1° Brix, indicating a loss of solids and water absorption. The dipping increased the vitamin C content to 20.2 mg/100 g (w.b.) from 5.9 mg/100 g (w.b.) of fresh sliced apples. This was due to the absorption of vitamin C from the dipping solution.

Both apple and strawberry bars became darker with a decrease in moisture content. The moisture content also influenced the color of frozen bars (p<0.05). As the moisture content decreased, L and b values of frozen apple bar increased while a values of frozen bar slightly decreased. Fresh apple contains yellow and green pigments (phenolic and chlorophyll) in its flesh. During dehydration, these natural color pigments were concentrated, resulting in an increase of b value (more yellow) and a decrease of a value (greener). When moisture was removed, all the Hunter color parameters of strawberry bar increased in the beginning and slightly decreased in the later stages of drying. Strawberry has red pigment (anthocyanin) in its flesh. The quick dehydration in the early drying state resulted in the concentration of red pigments and the increase of b value (more yellow) and a value (more red). In the later drying state, the red pigment might be degraded since anthocyanin is sensitive to heat, so that a and b values slightly decreased.

The hardness of restructured frozen fruit bars decreased with the decrease in moisture content. It is believed that this was because less free water was available to form ice crystals during freezing after the pre-dehydration. It has been observed that the frozen apple bars generally had lower hardness values than the frozen strawberry bars at the same moisture content, due to the difference in soluble solids. The high soluble solids in apple bars corresponded to high sugar content (low water activity) acting as cryoprotectant. When the hardness results are plotted against the water activities, it was found that the similar hardness was obtained at the same water activity regardless of the fruit variety. Therefore, controlling the water activity allows one to achieve a particular hardness.

An informal sensory evaluation of the frozen bars was also conducted in the Food Processing Laboratory in the Department of Biological and Agricultural Engineering, University of California, Davis. In general, based on the color and hardness of the frozen bars, all bars with water activity below 0.97 were judged as pleasing by the voluntary testers. Typically, water activities of the frozen bars are 0.96 to 0.97, which correspond to the moisture contents of from 81.4% to 88.2% (w.b.) for apple bars and 76.0% to 83.7% (w.b.) for strawberry bars.

If a restructured frozen whole apple bar is made by reducing water activity to 0.96 (moisture content of 83.5%), 28.5% and 218.4%, more total phenolic and vitamin C will be available, respectively, compared to the same amount of fresh apples. Similarly, if a restructured frozen whole strawberry bar is made by reducing water activity to 0.97 (moisture content of 81.8%), 37.0% and 73.3%, more total phenolic and vitamin C will be available, respectively, compared to the same amount of fresh strawberry. Based this research, a 100 g frozen fruit bar can provide the full recommended daily allowance of Vitamin C (based on a 2000 calorie diet; for adults and children 4 or more years of age, USDA, see e.g., U.S. Department of Health and Human Services and U.S. Department of Agriculture. Dietary Guidelines for Americans, 2005. 6th Edition, Washington, D.C.: U.S. Government Printing Office, January 2005). Since the dietary fiber and minerals in the dehydrated fruits do not change, dehydration increases the concentrations of the nutrients. Assuming that 100 g fresh apple contains 1.27 g total dietary fiber, a 100 g frozen bar with 83.5% moisture content will have 1.90 g dietary fiber, which provides 7.6% of the daily recommended dietary fiber. Similarly, if assuming that 100 g fresh strawberry contains 1.97 g total dietary fiber, a 100 g frozen bar with 81.8% moisture content can provide 19.7% of recommended daily dietary fiber.

TABLE 5
Total phenolic and vitamin C contents of frozen bars with
different moisture contents (per 100 g)

| | | Total phenolic | |
|---|---|---|---|
| | Moisture content (g) | (mg) | Vitamin C (mg) |
| Apple | 89.0 ± 0.3 (Fresh) | 152.7 ± 1.9 | 5.9 ± 1.3 |
| | 90.1 ± 0.3 (Dipped) | 168.2 ± 2.1 | 20.2 ± 3.6 |
| | 89.0 ± 0.3 | 154.1 ± 3.2 | 19.1 ± 1.6 |
| | 87.6 ± 0.2 | 164.9 ± 4.9 | 18.3 ± 1.6 |
| | 85.9 ± 0.1 | 176.6 ± 8.1 | 17.5 ± 1.7 |
| | 83.5 ± 0.1 | 196.3 ± 15.0 | 18.8 ± 1.8 |
| | 80.2 ± 0.2 | 224.9 ± 4.6 | 20.4 ± 1.7 |
| | 75.3 ± 0.2 | 260.1 ± 14.1 | 23.2 ± 1.5 |
| Strawberry | 92.7 ± 0.2 (Fresh) | 203.8 ± 3.5 | 52.1 ± 1.3 |
| | 91.4 ± 0.1 | 158.1 ± 1.7 | 53.6 ± 1.9 |
| | 89.6 ± 0.2 | 182.6 ± 8.7 | 60.6 ± 1.3 |
| | 86.8 ± 0.3 | 209.4 ± 3.4 | 72.7 ± 1.9 |
| | 81.8 ± 0.2 | 279.1 ± 6.1 | 90.2 ± 0.9 |
| | 70.8 ± 0.1 | 438.6 ± 10.4 | 134.4 ± 4.3 |

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of manufacturing a frozen food product comprising fruits and/or vegetables, the method comprising:
(i) preparing a food item for pre-dehydration to produce a prepared food item;
(ii) pre-dehydrating the prepared food item to produce a pre-dehydrated food item;
(iii) heating pre-dehydrated food item to achieve a desired water content, thereby producing a partially dehydrated food item;
(iv) grinding the partially dehydrated food item to produce a homogeneous mash;
(v) placing the homogeneous mash in a mold to produce a molded mash; and
(vi) freezing the molded mash to produce a frozen food product comprising fruits and/or vegetables.

2. The method of claim 1 further comprising:
(vii) removing the frozen food product from the mold.

3. The method of claim 1, wherein preparing a food item for pre-dehydration comprises:
washing the food item.

4. The method of claim 3, wherein preparing a food item for pre-dehydration further comprises:
peeling and slicing the food item.

5. The method of claim 3, wherein preparing a food item for pre-dehydration further comprises:
slicing the food item.

6. The method of claim 1, wherein preparing a food item for pre-dehydration comprises:
blanching the food item prior to pre-dehydration.

7. The method of claim 1, wherein pre-dehydrating the prepared food item comprises:
infrared dry blanching the prepared food item.

8. A frozen food product made according to the method of claim 1.

9. The frozen food product of claim 8, wherein the water activity of the frozen food product is in a range that is between about 0.90 and about 0.98.

10. The frozen food product of claim 9, wherein the water activity of the frozen food product is in a range that is between about 0.91 and about 0.97.

11. The frozen food product of claim 8, wherein the frozen fruit product comprises pre-dehydrated food in an amount that is in a range that is between about 80% to about 100%.

12. A method of manufacturing a frozen food product comprising fruits and/or vegetables, the method comprising:
(i) preparing a food item for pre-dehydration to produce a prepared food item;
(ii) pre-dehydrating the prepared food item using infrared dry blanching technology to produce a pre-dehydrated food item;
(iii) heating pre-dehydrated food item to achieve a water content that provides a water activity of the frozen food product is in a range that is between about 0.90 and about 0.98, thereby producing a partially dehydrated food item;
(iv) grinding the partially dehydrated food item to produce a homogeneous mash;
(v) placing the homogeneous mash in a mold to produce a molded mash; and
(vi) freezing the molded mash to produce a frozen food product comprising fruits and/or vegetables.

13. The method of claim 12 further comprising:
(vii) removing the frozen food product from the mold.
